(19) United States
(12) Patent Application Publication
(10) Pub. No.: US 2008/0044563 A1
(43) Pub. Date: Feb. 21, 2008

(54) Method of Treating Aluminum-Wheel Surface

(75) Inventors: Kazuyuki Kobayashi, Kanagawa (JP); Masami Uranaka, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION

(21) Appl. No.: 10/584,643

(22) PCT Filed: Dec. 27, 2004
(86) PCT No.: PCT/JP04/19530

§ 371 Date: May 29, 2007

(30) Foreign Application Priority Data
Dec. 26, 2003 (JP) 2003-431933

(51) Int. Cl. B05D 7/14; B05B 7/14

(52) U.S. Cl. 427/195; 118/312

(57) ABSTRACT

A method of treating an aluminum-wheel surface for removing an alkaline material without damaging the aluminum surface to improve the adhesion of a coating to the aluminum base material. The method achieves a corrosion resistance equivalent to that obtained by treatment using chromic acid chromate containing hexavalent chromium, without adversely affecting the health of workers and the environment. The method includes a blasting process for blowing a casting material onto the aluminum-wheel surface. The casting material includes plastic particles ranging in size from 100 to 2000 μm and containing a thermosetting resin as the main ingredient.

### TECHNICAL FIELD

The present invention relates to methods of treating aluminum-wheel surfaces. More specifically, the present invention relates to methods of treating aluminum-wheel surfaces for removing extraneous matter or coatings on the surfaces of the aluminum wheels by blasting.

### BACKGROUND ART

In general, a treatment prior to coating of aluminum products is conducted through steps of hot-water washing, degreasing, water washing, chemical conversion treatment, and water washing. However, in aluminum products produced by high-pressure casting, in particular, by squeeze casting, mold release agents (alkaline materials) adhere to the surfaces of the products. The adhered materials cannot be completely removed by existing washing processes, which is a problem.

When the product surfaces undergo a chemical conversion process using hexavalent chromium such as chromic acid chromate, the surfaces melt due to the high oxidative activity of hexavalent chromium to form coatings of chromic oxide. The coatings highly protect the surfaces from being corroded. Consequently, even if alkaline materials are present, good adhesion to metal can be retained. Recently, however, it has been determined that hazardous substances such as hexavalent chromium, lead, mercury, and cadmium will not be allowed to be used under the End-of-Life Vehicles (ELV) regulations, the Waste Electrical and Electronic Equipment (WEEE) regulations, and the Restriction of the use of certain Hazardous Substances in electrical and electronic equipment (RoHS) regulations in EU countries. Auto-parts manufacturers are required to produce products not containing such substances in coating materials applied thereon. Therefore, the chemical conversion process using hexavalent chromium, which is widely conducted in existing manufacturing of aluminum parts, must be terminated and changed to a chemical conversion process not using hexavalent chromium (i.e., to chromium-free treatment). Accordingly, various studies on chromium-free treatment have been conducted.

In chromium-free treatment, zinc phosphate, zirconium phosphate, titanium phosphate, or an anodic oxide film is used. However, these substances do not have an oxidative activity as high as that of hexavalent chromium. Therefore, when mold release agents (alkaline materials) adhere to and remain on aluminum surfaces by high-pressure casting, the adhesion of a coating to base materials may decrease. Thus, such chromium-free treatment is not satisfactory.

Accordingly, a method is necessary for removing alkaline materials adhered to the surfaces of aluminum products. There has not been such a method of removing only alkaline materials on the surfaces without damaging the surfaces of the aluminum base materials within a short time.

The above-mentioned chromium-free treatment cannot achieve a corrosion resistance equivalent to that obtained by the treatment with chromic acid chromate containing hexavalent chromium. Therefore, according to the various regulations, a method of treating a surface prior to coating, which can be a replacement for chromic acid chromate treatment, is required for providing the surface with higher corrosion resistance.

In methods for removing defective coatings of products, generally, solvents are widely used. Many of the solvents commonly used in removing the coatings are volatile organic solvents. Such solvents are hazardous to the health of workers. In addition, the disposal of the solvents is troublesome. Hence, the use of volatile organic solvents is also reconsidered from the viewpoint of protecting the environment.

Recently, in EU countries, the Volatile Organic Compound (VOC) regulations have been enacted for regulating the use of volatile organic solvents. Thus, there is a tendency to reduce the consumption of hazardous organic solvents. In Japan, the use of organic solvents is strictly controlled by the Pollutant Release and Transfer Register (PRTR) Law. In addition, the use is strictly regulated by the Air Pollution Control Law, the Water Pollution Control Law, and the Environmental Quality Law.

Under such circumstances, in some cases, the coatings of aluminum products are removed by blasting. In general, the coatings are removed with stainless steel shot commonly used in a shot peening process.

Disadvantageously, however, by using stainless steel shot, not only the coatings but also the aluminum surfaces are scraped away. Therefore, portions where cutting fabrication has already been applied must be re-fabricated. Additionally, edges are chipped by the high cutting ability of stainless steel and formed into a round shape (corner sags); which is a problem. Furthermore, when the coating is performed by means of a method, such as powder coating, which forms highly thick coatings, the removal of the coatings is sometimes troublesome; which is also a problem.

Furthermore, it is possible to use shot materials having relatively low hardness, such as zinc and copper, as the casting materials. However, since zinc makes the aluminum surfaces dull, it is generally difficult to apply zinc to the removal of the coatings. With respect to copper, the aluminum surfaces are corroded by the remaining copper thereon. Thus, copper cannot be used.

Additionally, plastic casting materials using resins as substrates are known as disclosed in Patent Documents 1 and 2. In addition, Patent Document 3 discloses a method of treating a surface of a base material by blasting prior to a coating process. The blasting is performed by blowing a casting material composed of resin particles not containing a surfactant. It is also disclosed that the main ingredient of the resin particles is a thermosetting resin and that an aluminum substrate plate is treated with the particles.

### Patent Document 1: Japanese Unexamined Patent Application Publication No. 2001-277129 (claims)

### Patent Document 2: International Publication WO 00/45994

### Patent Document 3: Japanese Unexamined Patent Application Publication No. 2003-311210 (claims and paragraph [0042])

### DISCLOSURE OF INVENTION

### Problems to be Solved by the Invention

A first purpose of the present invention is to provide a method of treating an aluminum-wheel surface, wherein the adhesion of a coating to an aluminum base material can be improved by removing an alkaline material adhered to the aluminum surface without damaging the surface. The alkaline material is troublesome when the above-mentioned various ways of chromium-free treatment are performed.

A second purpose of the present invention is to provide a method of treating an aluminum-wheel surface as treatment of the surface prior to a chromium-free coating process. The method can achieve a corrosion resistance substantially equivalent to that obtained by the treatment with chromic acid chromate containing hexavalent chromium.

A third purpose of the present invention is to provide a method of treating an aluminum-wheel surface, which does not adversely affect the health of workers and the environment and can remove a coating without damaging the surface of the aluminum material.

### Means for Solving the Problem

In order to solve the above-mentioned problems, a method of the present invention for treating an aluminum-wheel surface includes a blasting process of blowing a casting material onto the aluminum-wheel surface. The casting material is composed of plastic particles ranging in size from 100 to 2000 μm and containing a thermosetting resin as the main ingredient.

In the present invention, a hexavalent-chromium-free chemical conversion process is preferably conducted after the blasting process. In addition, the method can be suitably applied to an aluminum wheel having a mold release agent adhered to the surface of the wheel. In such a case, washing of the surface is conducted between the blasting process and the chemical conversion process. Furthermore, the present invention can be suitably applied to an aluminum wheel the surface of which is coated with a coating.

### Advantageous Effect of the Invention

By employing the above-mentioned method in accordance with the present invention, the surface area of an aluminum wheel can be increased before chromium-free treatment. Consequently, the adhesion of a coating to be applied to the surface is improved. When the method is applied to an aluminum wheel having a mold release agent adhered to the surface of the wheel, both blasting and washing are conducted prior to chromium-free treatment. Thus, only the film of the mold release agent can be broken into pieces and removed by the washing without damaging the aluminum base material. Consequently, the adhesion of a coating to the surface can be improved. Furthermore, when the method of the present invention is applied to an aluminum wheel the surface of which is coated with a coating, only the coating can be removed without damaging the surface of the aluminum material. Even if an aluminum wheel has a thick coating such as a powder coated product, the coating can be removed within a short time. In the surface-treating method in accordance with the present invention, a plastic casting material is used. Therefore, the aluminum surface is not unnecessarily damaged and the appearance impairment due to scraping does not occur, unlike the cases of using metal casting materials. In addition, the method can be performed without adversely affecting the health of workers and the environment. Thus, the method can be suitably applied to various aluminum wheels.

### BRIEF DESCRIPTION OF THE DRAWINGS

FIG. 1 is an explanatory diagram showing an increase in the surface area by blasting.

FIG. 2 is a cross-sectional view of an internal structure of a nozzle taken along the longitudinal direction of the nozzle which can be suitably employed in the method in accordance with the present invention.

FIG. 3 is a partially cut away front view of an apparatus used for treating an aluminum-wheel surface in accordance with the present invention.

### REFERENCE NUMERALS

1 inlet

2 throat

3 outlet

11 rotating shaft

12 nozzle

13 blast booth

14 door

15 window

16 working glove

17 blast hose

18 air supply port

19 casting material tray

### BEST MODE FOR CARRYING OUT THE INVENTION

The embodiments in accordance with the present invention will now be described in detail.

The present invention provides a method of treating an aluminum-wheel surface. The method includes a blasting process for blasting a casting material onto the aluminum-wheel surface. The casting material is composed of plastic particles ranging in size from 100 to 2000 μm and containing a thermosetting resin as the main ingredient.

By the blasting process, microscopic asperities are formed on the aluminum surface to increase the surface area. As a result, the adhesion of a coating to the surface is improved. Then, a chemical conversion process not using hexavalent chromium, namely, chromium-free treatment is performed. Thus, a corrosion resistance that is equivalent to that obtained by chemical conversion treatment using hexavalent chromium can be achieved. In other words, in the present invention, self-corrosion resistance obtained by chemical conversion treatment using hexavalent chromium cannot be achieved. However, the aluminum surface can be prevented from being corroded by retarding the progress of string corrosion through pinholes in a coating by improving the adhesion of the coating to the surface. Thus, the blasting process according to the present invention is effective as pretreatment of a surface in advance of a hexavalent-chromium-free chemical conversion process. Therefore, the combination of these pretreatment processes can achieve a performance equivalent to that obtained by chemical conversion treatment using hexavalent chromium.

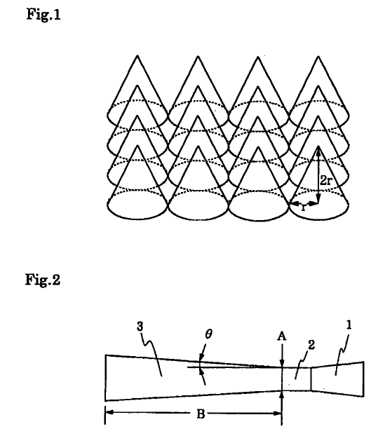

Specifically, it is thought that the blasting forms asperities as shown in FIG. 1 on a surface of a flat board. In model calculation when it is assumed that conic projections are formed as shown in the drawing, the surface area of a cone having a base of r and an altitude of 2r is represented by “πr² times the square root of 5”. In this case, the base area of each cone is πr². Therefore, the surface where cones are formed by blasting has an increase in the surface area by “the square root of 5” times compared to that before the forming of the cones.

Furthermore, the blasting may be applied to a rough surface prepared by shot blasting using a metal material so that further fine asperities are formed on the surface to increase the surface area. Additionally, a surface provided with desired asperities can be obtained by changing the diameter and the hardness of the plastic casting material.

When the method of the present invention is applied to an aluminum wheel having a mold release agent adhered to the surface of the wheel, washing of the surface is conducted between the blasting and the chemical conversion processes. When high-pressure casting, in particular, squeeze casting is employed, a film of a mold release agent (alkaline material) adhered to an aluminum surface cannot be removed by blasting alone. However, it is thought that the alkaline material is broken by blasting and removed by washing performed in accordance with the present invention, and as a result, the alkaline material can be removed from the aluminum surface. Consequently, the adhesion of a coating to the aluminum base material can be improved.

After the blasting, a washing process and a chemical conversion process may be conducted, for example, through steps of blasting, hot-water washing, degreasing, water washing, chemical conversion treatment, and water washing. Other processes may be employed.

When the present invention is applied to an aluminum wheel the surface of which is coated with a coating, workers are not exposed to hazardous materials such as organic solvents. Therefore, the workers can remove the coating in safety and within a short time. On the other hand, when a coating is removed by using a conventional solvent, the removing takes about 3 to 5 hours depending on the thickness of the coating. In addition, since a plastic casting material is used as the blast material in the present invention, a coating can be removed without substantially damaging an aluminum material itself. Thus, advantageously, re-fabrication of the aluminum material is unnecessary.

Furthermore, according to the present invention, a coating can be removed from a surface without scraping the surface unlike a case using a metal casting material. Therefore, re-coating can be performed without any problem. Accordingly, the coating and removing processes can be repeated many times though they can be generally conducted two times at most in a conventional method. In addition, because of high grinding efficiency, even if an aluminum wheel has a thick coating such as a powder coated product, the coating can be removed within a short time, and the aluminum surface is not corroded. The casting material of the present invention does not penetrate into surfaces of aluminum materials unlike a case using a metal casting material. Thus, since the blasting does not affect the surface, the surface states of aluminum materials after the removing of coatings substantially the same as each other. Although dust particles adhere electrostatically to an aluminum surface, the dust particles on the surface can be readily removed through a prescribed washing process.

In such a case, a coating may be removed by conducting both blasting and solvent treatment, The coating surface may be roughly removed not to damage an aluminum surface by firstly using a metal casting material, and then the coating may be completely removed by using a plastic casting material.

Additionally, the particle size and the hardness of a plastic casting material may be optionally changed. For example, a system of two or more stages, in which blasting is conducted more than once, may be employed by firstly blasting with large or hard casting particles and then with smaller (or less hard) particles as a finishing process. In the case of employing such a multistage system, the blasting material is not limited to the above-mentioned metal and plastic casting materials. Any material having a hardness equivalent to that of the metal or plastic casting material can be also used.

In the present invention, any thermosetting resin may be used as a casting material (blast material) without specific limitation. Examples of the thermosetting resin include melamine resins (melamine-formaldehyde resins). urea resins (urea-formaldehyde resins), polycarbonate resins, phenol resins, epoxy resins, unsaturated-polyester resins. acrylic resins, guanamine resins, and polyurethane resins. In addition, other resins having hardness equivalent to those of these resins may be used. Such casting materials can be repeatedly used for about 30 to 40 times by collecting the materials after the blowing and circulating them.

Preferably, the plastic casting material is a pulverized thermoset resin having a particle size of 50 to 1000 μm, for example. Each particle is substantially an amorphous polyhedron having a sharp edge line. The particle size of each particle size classification of the pulverized particles is roughly homogeneous. Such pulverized particles can be prepared according to a method disclosed in the Patent Document 2.

As a blasting device used for the surface-treating method in accordance with the present invention, an air-blasting device allowing direct injection is suitable, but not limited to this. Centrifugal or barrel blasting can be employed. The device may be optionally selected depending on the use and the environment of use.

Any nozzle can be used for blasting a plastic casting material without specific limitation. A Nozzle generally used in blasting can be optionally used. Specifically, in the present invention, a nozzle having a predetermined shape described below is preferably used. The internal diameter of the nozzle widens from the end of an inner throat toward the tip of an outlet at an extent angle θ of 0.5 to 1.5° in the longitudinal direction of the nozzle. The ratio (B/A) of the length B between the end of the throat and the tip of the outlet to the diameter A of the throat is greater than or equal to 10. Such a nozzle is suitable as a high-performance nozzle exclusively used for blasting a plastic abrasive material.

FIG. 2 shows a cross-sectional shape when such a nozzle is cut along the longitudinal direction thereof. As shown in the drawing, the internal structure of the nozzle is composed of an inlet 1, a throat 2, and an outlet 3. The diameter of the outlet 3 widens from the end of the throat 2 toward the tip of the outlet at an extent angle θ of 0.5 to 1.5°, preferably 1.0 to 1.3° in the longitudinal direction of the nozzle. When the extent angle θ is less than 0.5° or higher than 1.5°, the removing performance is inadmissibly decreased.

In the nozzle shown in the drawing, the ratio (B/A) of the length B between the end of the throat 2 and the tip of the outlet 3 to the diameter A of the throat 2 is greater than or equal to 10, preferably 15 to 25. When the ratio is lower than 10, the removing performance is inadmissibly decreased. On the other hand, a nozzle having a ratio exceeding 25 is unpractical.

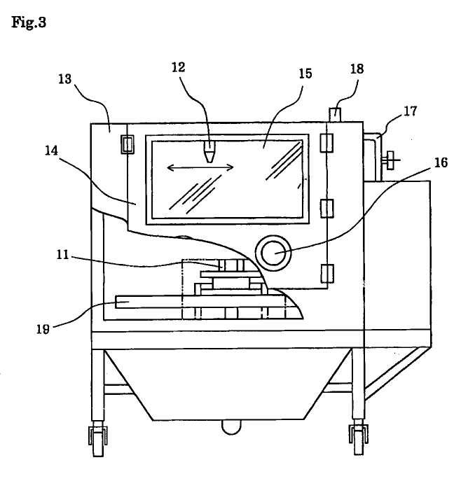

The surface-treating method of the present invention can be suitably conducted by using, for example, the apparatus shown in FIG. 3 in accordance with the present invention. The apparatus shown in the drawing includes a rotating shaft 11 fixing and rotating an aluminum wheel, a nozzle 12 positioned apart from the rotating shaft so as to face the shaft in the axis direction thereof, a rotating mechanism (not shown) for controlling the rotation of the rotating shaft 11, and a transferring mechanism (not shown) for transferring the nozzle 12 in a linear reciprocating motion in the radial direction of the aluminum wheel. Therefore, the blasting of an aluminum-wheel surface can be efficiently conducted by blowing a casting material from the nozzle 12 positioned at the vertically upper side of the apparatus shown in the drawing while rotating the aluminum wheel fixed to the rotating shaft 11. Here, the transferring mechanism transfers the nozzle 12 in the radial direction of an aluminum wheel when the nozzle 12 blows a casting material to the wheel. When the moving speed and the rotating speed are constant, the amount of the casting material applied per unit surface area increases as the nozzle 12 approaches the center of the aluminum wheel. As a result, the state of the surface after blasting is uneven. Therefore, in order to achieve uniform removing of a coating by keeping the removing speed constant in the apparatus of the present invention, at least one of the rotating mechanism and the transferring mechanism is formed so as to be speed-controllable. Thus, good treatment can be achieved by operating the transferring mechanism and/or the rotating mechanism at a higher speed according to the nozzle 12 approaching the center of the wheel. In the apparatus shown in the drawing, a reference numeral 13 represents a blast booth, a reference numeral 14 represents a door having a window 15, a reference numeral 16 represents a working glove for externally performing internal operation, a reference numeral 17 represents blast hose for supplying a casting material, a reference numeral 18 represents an air supply port, and a reference numeral 19 represents a casting material tray. The inside of the blast booth 13 is provided with an opening (not shown) for collecting a used casting material at the lower side and a transferring mechanism (not shown) for transferring the nozzle 12 on the upper surface.

### EXAMPLES

Exemplary Examples of the surface-treating method in accordance with the present invention will now be described.

### SST Test

Samples (blasted samples) the surfaces of which were pretreated by blasting and samples (not-blasted samples) the surfaces of which were not pretreated by blasting were prepared. Each of the blasted samples and the not-blasted samples was treated with chromic acid chromate or a chromium-free material (zinc phosphate or zirconium phosphate), and then subjected to a salt spray test (SST). The samples were aluminum die casts (aluminum-wheel cut samples, Barcol hardness: 80). The blasting was performed by using a direct pressure blasting apparatus and using MG-3 (tradename, manufactured by Bridgestone Corporation) having a particle size of 500 to 850 μm as a casting material under the conditions of a blowing pressure of 0.45 MPa, a blowing distance of about 100 mm, and a blowing time of 30 sec. The nozzle shown in FIG. 2 having a tip diameter of 6 mm was used. The surface roughness Ra after the treatment was 5 to 6 μm.

The results show that there was not difference in corrosion resistance between a not-blasted sample treated with chromic acid chromate and a blasted sample treated with the chromium-free material. Thus, it was confirmed that the performance of both samples was substantially the same. In other words, it was confirmed that even if the chromium-free material was used for the treatment, a corrosion resistance equivalent to that obtained by the treatment with chromium acid chromate can be obtained by blasting the surface in accordance with the present invention.

### BTB Solution Reaction Test

Aluminum die cast samples (aluminum wheel cut samples, Barcol hardness: 80) having a mold release agent, an alkaline material, adhered to the surfaces of the samples were subjected to blasting under the conditions as in the SST test except that the blowing time was 90 sec. Then, the samples were subjected to a predetermined washing process and tested by using a BTB solution (PH test solution) to clearly observe a change in color. Thus, it was obviously confirmed that the alkaline material can be removed by the blasting.

### Evaluation of Adhesion of Coating

To a blasted aluminum-wheel sample and a not-blasted aluminum-wheel sample, a comparative test of adhesion of a coating was conducted. The results show that the adhesion of the not-blasted sample was decreased by chromium-free treatment but that of the blasted sample was well retained.

### Delamination Test of Coating

Aluminum wheels provided with various types of coating were prepared and subjected to a delamination test. Only the coatings were completely removed without damaging the surfaces in all the aluminum wheels though the treating times were different depending on the size and the thickness of the coating. It was also confirmed that the time for removing a coating can be shortened by using a plurality of nozzles and a rotating table. The surface roughness was not largely changed.

In addition, dust particles adhered to the surfaces of aluminum wheels after blasting were readily removed by washing the surfaces in every test and evaluation above.

### INDUSTRIAL APPLICABILITY

The method of treating a surface in accordance with the present invention can be suitably applied to treatment prior to coating and to removal of coatings of various aluminum wheels for four-wheeled vehicles and two-wheeled vehicles. In addition, the method can be used for recycling products having defective coatings or for changing the color of a coating.

1. A method of treating an aluminum-wheel surface, the method comprising a blasting process for blowing a casting material onto the aluminum-wheel surface, the casting material being composed of plastic particles ranging in size from 100 to 2000 μm and containing a thermosetting resin as the main ingredient, and a chemical conversion process not using hexavalent chromium after the blasting process.

2. (canceled)

3. The method in accordance with claim 1, the method being applied to an aluminum wheel having a mold release agent adhered to the surface of the aluminum wheel and further comprising a washing process between the blasting process and the chemical conversion process.

4. The method in accordance with claim 1, the method being applied to an aluminum wheel the surface of which is coated with a coating.

5. The method in accordance with claim 4, wherein the blasting process is conducted more than once by changing the diameter and/or hardness of the plastic particles.

6. The method in accordance with claim 4, further comprising a solvent-treating process using a solvent.

7. The method in accordance with claim 4, further comprising a blasting process using a metal casting material.

8. The method in accordance with claim 1, wherein the casting material is collected after the blasting and is circulated for repeated use thereof.

9. The method in accordance with claim 1, wherein an air-blasting device is used.

10. The method in accordance with claim 1, wherein the plastic particles are a pulverized thermoset resin having a particle size of 100 to 1000 μm, each particle is substantially an amorphous polyhedron having a sharp edge line, and the particle size of each particle size classification of the pulverized particles is roughly homogeneous.

11. The method in accordance with claim 1, wherein the blowing of the plastic particles involves the use of a nozzle having a diameter widening from the end of an inner throat toward the tip of an outlet of an extent angle θ of 0.5 to 1.5° in the longitudinal direction of the nozzle, and a ratio (B/A) of the length B between the end of the throat and the tip of the outlet to the diameter A of the throat is greater than or equal to 10.

12. An apparatus for treating an aluminum-wheel surface by blasting the aluminum-wheel surface with a casting material, the apparatus comprising:
a blast booth having an opening for collecting a used casting material at the lower side of the inside;
a rotating shaft for fixing and rotating the aluminum wheel inside of the blast booth;
a nozzle positioned apart from the rotating shaft so as to face the rotating shaft in the axis direction thereof;
a rotating mechanism for controlling the rotation of the rotating shaft; and
a transferring mechanism for transferring the nozzle in a linear reciprocating motion in the radial direction of the aluminum wheel;
at least one of the rotating mechanism and the transferring mechanism being speed-controllable.
